(19) United States
(12) Patent Application Publication
(10) Pub. No.: US 2007/0103497 A1
(43) Pub. Date: May 10, 2007

(54) Driving method of ink-jet printer and its driving apparatus

(75) Inventor: Jun Takamura, Mishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/362,676

(22) Filed: Feb. 27, 2006

Related U.S. Application Data
(63) Continuation-in-part of application No. 11/269,407, filed on Nov. 8, 2005, now abandoned.

(51) Int. Cl. B41J 29/38

(52) U.S. Cl. 347/12

(57) ABSTRACT

A printer head is so structured that, with each time division groups given as A, B, C, the head and printing data are moved at predetermined speeds and, with the sequential drive order of the respective division groups given as A, B, C, a printing result emerges in one row in a nozzle direction to a relative moving direction of the head and printing medium. In this printer head, a driving is effected in a sequential drive order including C, B, A with a relative speed between the head and the printing medium set double its speed and print data corresponding to each time division is received and printed so that a printing result in the relative moving direction emerges at a pitch double that predetermined pitch and a printing result of the groups A, C nozzles and B nozzles emerges in a state displaced by a predetermined pitch.

### CROSS-REFERENCE TO RELATED APPLICATIONS

This is a Continuation-in-Part application of U.S. Pat. No. 1,126,9407, filed Nov. 8, 2005, now abandoned, the entire contents of which are incorporated herein by reference.

### BACKGROUND OF THE INVENTION

1. Field of the Invention

The present invention relates to a driving method of an ink jet printer and its driving apparatus.

2. Description of the Related Art

Where a printer head as shown in FIG. 8B is driven in three-time division fashion, a printing is made in a predetermined head drive frequency with a relative head/medium speed set to a predetermined speed. By doing so, a positional difference of nozzle groups corresponding to three divisions ceases to exist and, as shown in FIG. 8A, a printing is made in one line at a predetermined pitch in a nozzle direction.

Generally, in a serial printer, a printing is made in one line with the use of a plurality of nozzles and, by doing so, the printer is driven in a fashion less prominent in “print drops” and less “banding” resulting from a head-caused print variation. Here, the “banding” means a nonuniform concentration caused by a white line emerging on a recording medium due to the non-jetting of an ink from some nozzle as well as by the misdirection caused by some nozzle. In this case, it is known that, in the prior art technique, a printing is made by alternately using one half number of nozzles for each column and, by doing so, a printing is made a plurality of numbers as shown in FIG. 7A.

In FIG. 7B, reference numeral 11 shows a printing head. The nozzles 12 are provided in a zigzag fashion on a nozzle surface of the printing head 11. Those nozzles 12 are sequentially grouped in an A→B→C order from near the moving direction of the printing head 11. An Xab pitch is provided between the group A and the group B and an Xbc pitch between the group B and the group C.

As shown in FIG. 7A, a printing is made in an order of n−2, n−1, n, n+1, n+2 columns.

This printing is made in a sequential order of groups A, B, C for each column in a state to jet an ink from those nozzles belonging to the group. For the n−2 column, a printing is made at A1 belonging to group A, with no ink jetted from B2 due to no print data involved under group B, a printing is made at C1 under group C. And no ink is jetted at A2 due to no print data involved under group A and a printing is made at Bl under group B and no ink is jetted at C2 due to no print data under group C.

For the n−1 column, a printing is made at B11 under group B, at A12 under group A and at C12 under group C. In the n−1 column, a printing is made at B11 under group B, at A12 under group A and at C12 under group C. In the n−1 column, no ink is jetted from the rest due to no print data involved.

In this case, a printing was done using the relative speed of the head and recording medium as a predetermined speed. Since no half number of nozzles are not used for each column, it may be said that no effective use can be expected for the head.

Where a printing is effected at a coarse pitch with the above-mentioned relative speed increased from the state of FIG. 8A, a matched printing position is not obtained at the nozzle groups of each three divisions. As a result, as shown in FIG. 9A, a straight printing line is not obtained in the nozzle direction, thus presenting a problem. It is to be noted that FIG. 9B shows a printing head.

### BRIEF SUMMARY OF THE INVENTION

In one aspect of the present invention, there is provided a printing head driving method using a printer head configured to effect a three time division so as not to simultaneously print an adjacent channel and means for receiving print data corresponding to each time division and printing it, the printer head being so constructed that, with the respective time division groups given as A, B, C, the head and printing medium are moved at predetermined speeds and, with the sequential drive order given as A, B, C, a printing result emerges as one row in a nozzle direction at a predetermined pitch to a relative moving direction of the head and printing medium, the method comprising a step of effecting a driving in a sequential drive order including C, B, A with the relative driving speed of the head and printing medium set double its speed and a step of receiving print data corresponding to each division and making a printing so that a printing result in a relative moving direction emerges at a pitch double that predetermined pitch and a printing result of the group A, C nozzles and B nozzles emerges in a state displace by a predetermined pitch.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an ink jet printer according to one embodiment of the present invention;

FIG. 2 is a block diagram showing a controller of the ink jet printer;

FIG. 3 is a block diagram showing a head drive circuit of the ink jet printer;

FIG. 4 is a view showing a memory map of the present embodiment;

FIG. 5A is a timing chart for explaining an operation of the embodiment;

FIG. 5B is a timing chart for explaining an operation of the embodiment;

FIG. 5C is a timing chart for explaining an operation of the embodiment;

FIG. 5D is a timing chart for explaining an operation of the embodiment;

FIG. 5E is a timing chart for explaining an operation of the embodiment;

FIG. 6A is a view showing a printing example printed by a driving method of an ink jet printer of the embodiment;

FIG. 6B is a front view showing a printing head of the ink jet printer of the embodiment;

FIG. 7A is a view showing a printing example printed by a driving method of a conventional ink jet printer;

FIG. 7B is a front view showing a print head of this ink jet printer;

FIG. 8A is a view showing a printing example printed by a driving method of a conventional ink jet printer;

FIG. 8B is a front view showing a printing head of this ink jet printer;

FIG. 9A is a view showing a printing example printed in a drive order of ABC at a speed set as fast as double its predetermined speed; and

FIG. 9B is a front view showing a printing head of this ink jet printer.

### DETAILED DESCRIPTION OF THE INVENTION

With reference to the drawing an explanation will be made below about one embodiment of the present invention.

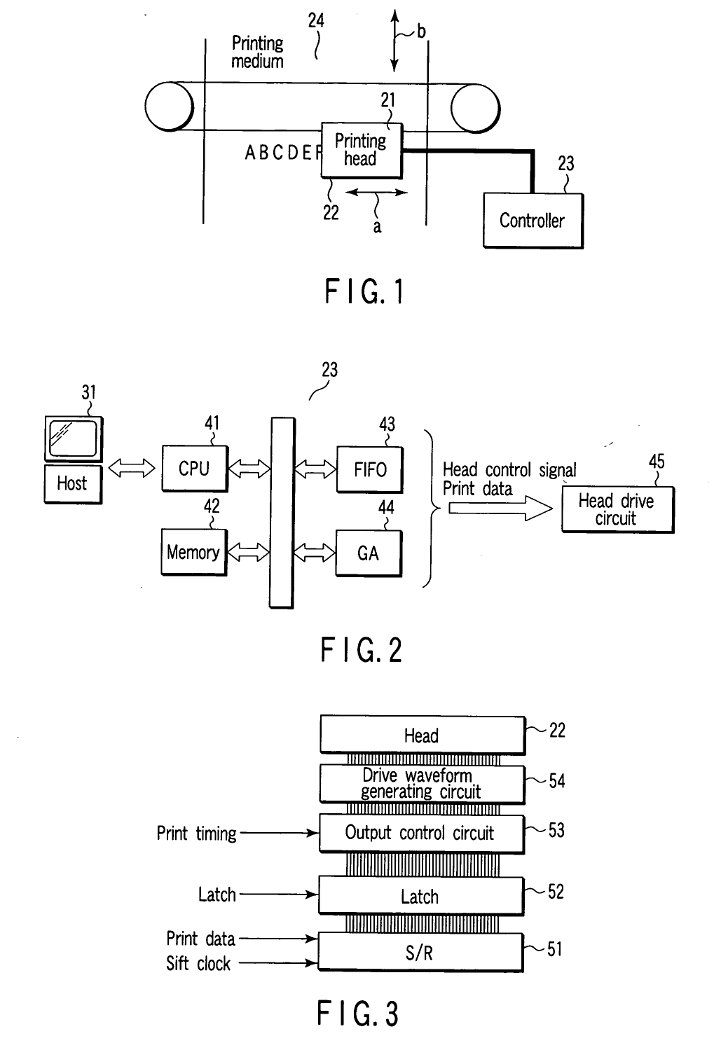

In FIG. 1, reference numeral 21 shows a printing head allowing three time divisions to be achieved without any simultaneous printing on an adjacent channel. The printing head 21 is mounted on a carriage 22. The control of the printing head 21 and carriage 22 is done by a controller 23.

Under the control of the controller 23, the carriage 22 is moved in right and left directions as indicated by an arrow a and a printing medium 24, while being conveyed in a direction (arrow b) perpendicular to the operation direction of the carriage 22, is printed so that an image is formed on it.

With reference to FIG. 2 an explanation will be made below in more detail about a block diagram of the controller 23. In FIG. 2, reference numeral 31 shows a host computer. To this host computer 31 is connected the controller 23.

The controller 23 comprises a CPU 41, a memory 42, a FIFO memory 43 and a GA (gate array) 44. From the FIFO memory 43 and GA 44, a head control signal and print data are sent to a head driving circuit 45. The head driving circuit 45 is provided in the controller 23. A detailed arrangement of the head driving circuit 45 is shown in FIG. 3.

With reference to FIGS. 5A to 5E, an explanation will be made below about a flow of the print data. The print data is such as to allow data corresponding to a few lines to be sent from the host computer 31 to a printer 32. The thus sent print data is written into a memory 42 through the CPU 41 and GA 44.

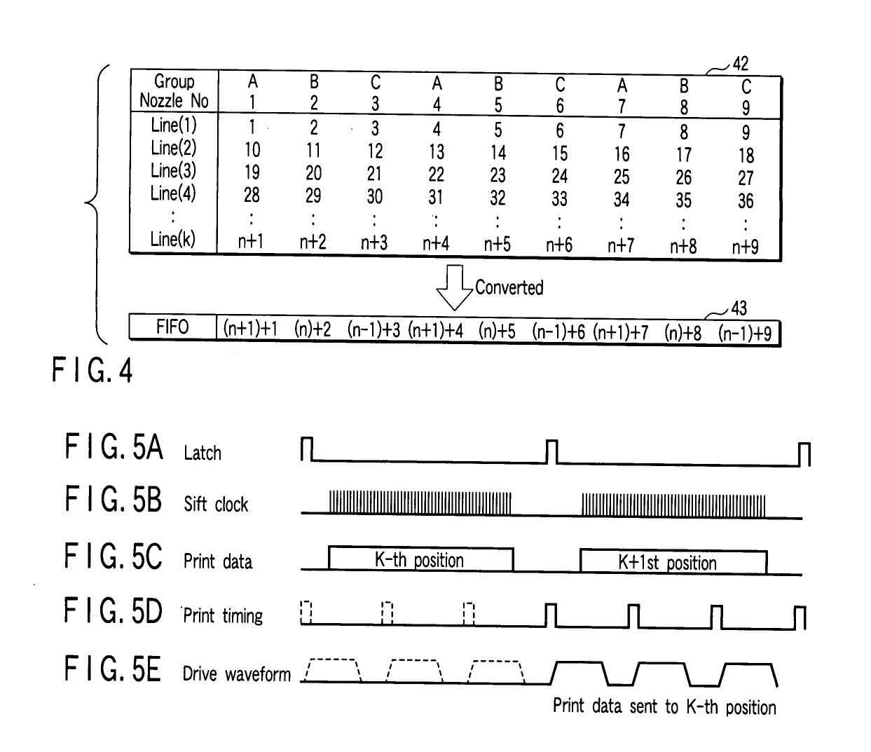

Before a printing is started, the print data written into the memory 42 is converted to a form shown in FIG. 4 and stored into the FIFO memory 43. Here, as shown in FIG. 7, nozzles are provided in a zigzag array on the printing head 21. As shown in FIG. 7, the nozzles are divided into three groups (A, B, C) and driven in a divided way.

That is, (n+1)st line data is stored for the group A data, (n)th line data for the group B data, and (n−1)th line data for the group C data (See FIG. 4).

It is to be noted that the print data, which is output from the FIFO memory 43, as shown in FIG. 5C is stored in the shift register (S/R) 51 shown in FIG. 3 by a shift clock shown in FIG. 5B. When the data is output from the FIFO memory 43, the next print data is converted and stored in the FIFO memory 43. Then when a latch signal shown in FIG. 5A is input to a latch circuit 52, the data of the shift register 51 is latched to the latch circuit 52. After this, the data stored in the FIFO memory 43 is stored in the shift register 51 by a shift clock.

Then after the inputting of the latch signal, a first timing signal (FIG. 5D) is input to an output control circuit 53. When the first timing signal is input to the output control circuit 53, if the group C print data (FIG. 5C) stored in the latch circuit 52 is 1, a drive waveform generating circuit 54 outputs a drive waveform (FIG. 5E) to a corresponding group C nozzle. By doing so, an ink is jetted from the group C nozzle to effect a printing.

Then, a second timing signal is input to the output control circuit 53. When the second timing signal (FIG. 5D) is input to the output control circuit 53, if the print data is 1 based on the group B print data (FIG. 5C) stored in the latch circuit 52, the drive waveform generating circuit 54 outputs a drive waveform (FIG. 5E) to a corresponding group B nozzle. By doing so, an ink is jetted from the group B nozzle to effect a printing.

Finally, a third timing signal is input to an output control circuit 53. When the third timing signal (FIG. 5D) is input to the output control circuit 53, if group A print data stored in the latch circuit 52 is 1, the drive waveform generating circuit 54 outputs a drive waveform (FIG. 5E) to a corresponding group A nozzle. By doing so, an ink is jetted from the group A nozzle to effect a printing.

In this way, the jetting of the ink from the nozzles of the groups A, B, C is completed. By repeating these operations, a printing is done.

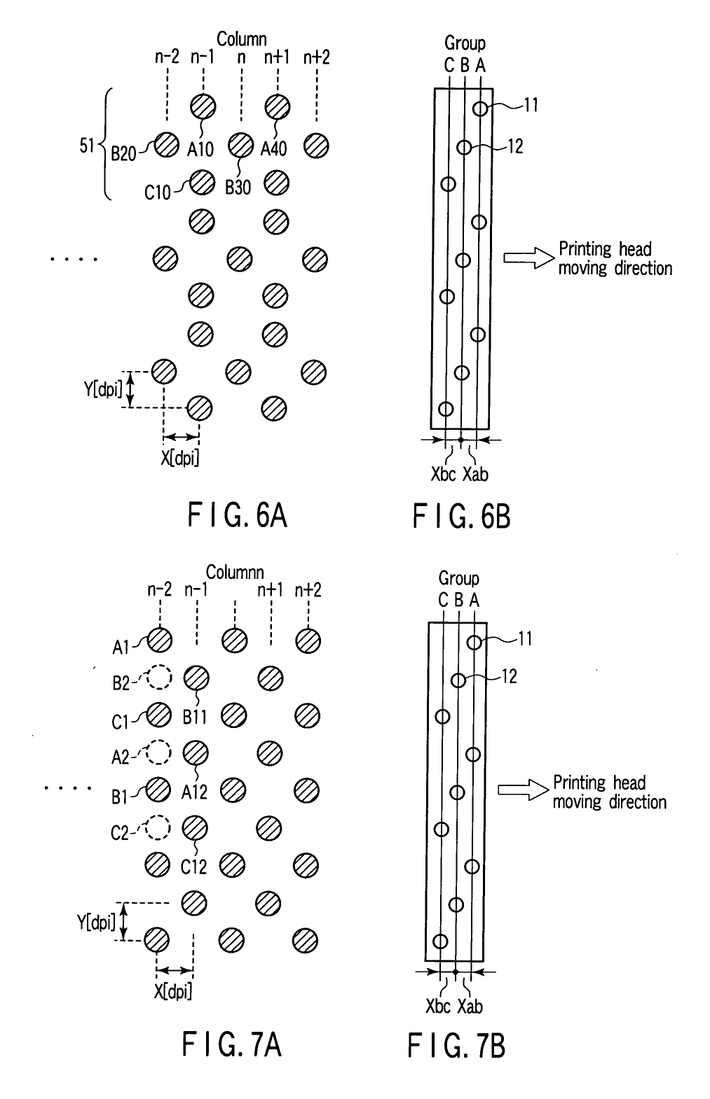

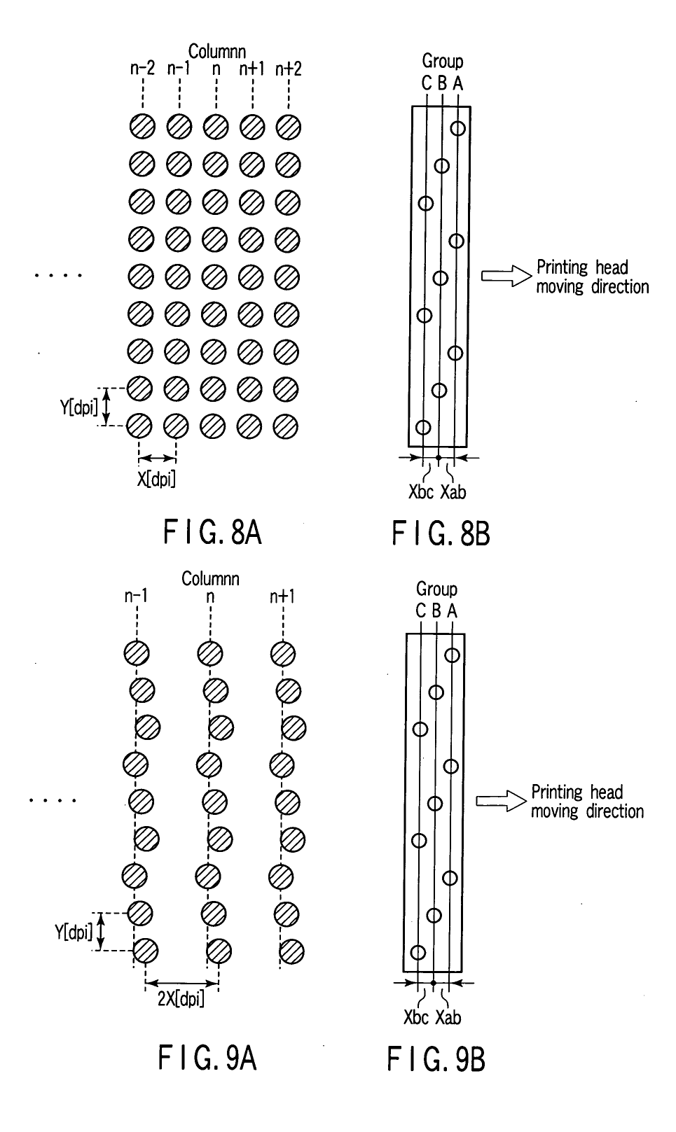

For a printing example as shown in FIGS. 6A and 8A, an ink is jetted in a sequential order of group A nozzle→group B nozzle→group C nozzle. At this time, it is given that the relative speed of the printing medium 24 and printing head 21 is 16 ips (406 mm/s), the image resolution of the printing head 21 in a moving direction is 300 dpi and the dot-to-dot drive frequency is 4800 Hz.

From such a state, with the relative speed of the printing medium 24 and printing head 21 given as a double speed (32 ips), an ink is jet-driven in the sequential order of group C nozzle→group B nozzle→group A nozzle.

And with the group A nozzle-group B nozzle and group B nozzle-group C nozzle intervals given as 1/900 inch (⅓ of 1/300 inch) image resolution, a printer is driven at 4800×14400 Hz at the respective group nozzle intervals and, by doing so, respective dots are deposited on a 300 dpi grid array.

That is, under the control of the following procedure with the use of the printing head 21 it is possible to, while moving the printing head 21 at a speed double its relative speed normally using all the nozzles, construct one line with a plurality of nozzles and to realize an accurate printing with a desired printing image resolution.

It is given that the printer is driven at a reverse order of the groups C→B→A instead of the order of A→B→C.

By driving the printer in this way, the printing interval between respective nozzles of the groups A, B, C becomes 150 dpi and a printing is made with the groups A and B and the groups C and B displaced 300 dpi in a moving direction.

In this case, for the groups A, B, C, a printing needs be effected at different columns and their corresponding print data may be transmitted to the head drive circuit 45.

An explanation will now be made in more detail while paying attention to a restricted area 51. A printing is effected in a sequence of a dot C10 at the group C nozzle, a dot B30 at the group B nozzle and a dot A40 at the group A nozzle.

A printing is made with a group B nozzle dot B20 at an n−1 column, and a group A nozzle dot A10 and group C nozzle dot C10 at the n−1 column.

By the above-mentioned control, it is possible to make a printing as shown in FIG. 6A. That is, in the case of FIG. 6A, it is possible to make a printing with a desired image resolution by twice printing operations. Here, the second printing is made by shifting the printing head 21 by an interval of 3Y×m(m is an integer not less than 0) (dpi) toward a direction perpendicular to a moving direction of the printing head 21. Printing is performed with the nozzles shifted by a pitch x in the conveying direction with respect to the first printing.

That is, one line can be comprised of different nozzles.

In this way, a 100% nozzle use efficiency can be achieved on the head and there is no unavailable area when compared with that of FIG. 7A.

Further, it is possible to set the moving speed of the head double its speed and to effect an accurate printing on a grid array of a desired image resolution and to construct one line with a plurality of nozzles. It is thus possible to obtain a better printing result compared to that of FIG. 7A.

Although, in the above-mentioned embodiment, an explanation has been made about a shared mode system, the present invention is not restricted to this system. If, for example, nozzles are arranged in a displaced fashion as shown in FIG. 7B and respective nozzle groups are driven in a time division fashion, the present invention can be applied to it.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A driving method of a print head comprising a printer head configured to effect three time division so as not to simultaneously print an adjacent channel and means for receiving print data corresponding to each time division and printing it, the printer head being so constructed that, with respective time division groups given as A, B, C, the head and printing medium are moved at predetermined speeds and, with a sequential drive order of the time division groups given as A, B, C, a printing result emerges at one row in a nozzle direction at a predetermined pitch to a relative speed direction of the head and printing medium, the method comprising:
effecting a driving in a sequential drive order including C, B, A, with the relative speed between the head and the printing medium set double its speed; and
receiving print data corresponding to each division and making a printing so that a printing result in the relative moving direction emerges at a pitch double that predetermined pitch and a printing result of the group A, C nozzles and the group B nozzles emerges in a state displaced by that predetermined pitch.

2. A driving method of an ink jet printer according to claim 1, further comprising moving the print head by 3Y×m (m is an integer not less than 0) with respect to a pitch Y in the nozzle direction, and performing printing with the nozzles shifted by a pitch x in the conveying direction with respect to preceding printing, thereby performing printing at predetermined pitches in an x-direction and a y-direction as a result of twice printing processes.

3. A driving method of an ink jet printer according to claim 1, wherein an interval between any of the groups A, B, C of the printer head is 150 dpi and an interval between a printing result between the groups A and B and a printing result between the groups B and C are 300 dpi.

4. A driving apparatus of an ink jet printer comprising:
a printer head configured to effect three time division so as not to simultaneously print an adjacent channel and means for receiving print data corresponding to each time division and printing it, the printer head being so constructed that, with the respective time division groups given as A, B, C, the head and printing medium are moved at predetermined speeds and, with a sequential drive order of the time division group given as A, B, C a printing result emerges in one row in a nozzle direction at a predetermined pitch to a relative moving direction of the head and printing medium; and
a controller configured to effect a driving in a sequential drive order including C, B, A with a relative speed between the head and the printing medium set double its speed and receive print data corresponding to each division and make a printing so that a printing result in the relative moving direction emerges at a pitch double that predetermined pitch and the printing result of the group A, C nozzles and group B nozzles emerge in a state displaced by a predetermined pitch.

5. A driving apparatus according to claim 4, wherein the control section moves the print head by 3Y×m (m is an integer not less than 0) with respect to a pitch Y in the nozzle direction, and performing printing with the nozzles shifted by a pitch x in the conveying direction with respect to preceding printing, thereby performing printing at predetermined pitches in an x-direction and a y-direction as a result of twice printing processes.

6. A driving apparatus according to claim 4, wherein the interval between any of groups A, B, C of the printer head is 150 dpi and the interval between the groups A and B and a printing result between the groups B and C is 300 dpi.
